(19) United States
(12) Patent Application Publication
(10) Pub. No.: US 2018/0321698 A1
(43) Pub. Date: Nov. 8, 2018

(54) THERMAL BALANCING VALVE AND SYSTEM USING THE SAME

(71) Applicant: Energx Controls. Inc., Cypress, CA (US)

(72) Inventors: Luther Jerry Watts, Winnetka, CA (US); Timothy Dale Krause, Cypress, CA (US)

(21) Appl. No.: 16/036,395

(22) Filed: Jul. 16, 2018

Related U.S. Application Data
(63) Continuation of application No. 14/983,532, filed on Dec. 30, 2015.
Application No. 14/983,532 is a continuation-in-part of application No. 14/789,878, filed on Jul. 1, 2015, now abandoned.
(60) Provisional application No. 62/020,792, filed on Jul. 3, 2014.

(51) Int. Cl. G05D 23/02; F16K 31/00

(52) U.S. Cl. CPC G05D 23/022; G05D 23/025; F16K 31/002

(57) ABSTRACT

A thermal valve for controlling a flow of fluid includes a housing having an inlet and an outlet configured to permit the flow of fluid through an interior of the housing, an actuator including heat-sensitive material configured to contract or expand based on a temperature of the fluid, a rod fixedly coupled to the housing and partially inside the actuator, the rod being configured to move relative to the actuator as the heat-sensitive material contracts or expands, a chamber inside the housing and fixedly coupled to the housing, the chamber being configured to accommodate the actuator, a first compressive resilient element configured to movably couple the actuator to the chamber, and a disc movably coupled to the chamber via a second compression element, and configured to permit flow of the fluid from the inlet to the outlet and to reduce flow of water from the outlet to the inlet.

### CROSS-REFERENCE TO RELATED PATENT APPLICATION

This application is a continuation of U.S. patent application Ser. No. 14/983,532, filed Dec. 30, 2015, which is a continuation-in-part of U.S. patent application Ser. No. 14/789,878, filed Jul. 1, 2015, which claims priority to and the benefit of U.S. Provisional Application No. 62/020,792, filed Jul. 3, 2014, the entire content of both of which is incorporated herein by reference.

### BACKGROUND

### 1. Field

The present invention relates to the field of hot water systems and heating systems for domestic and industrial use.

### 2. Description of Related Art

Hot water supply systems and hydronic heating systems generally include a number of regions and/or zones that supply hot water to different parts of a building or facility. Typically, the flow of water through each of these regions/zones is adjusted and balanced at an initial point in time (e.g., when the system becomes operational) under a particular set of operational conditions and is often not rebalanced during the life of the system. However, as operating conditions change, a system often drifts from its balanced position. For example, as the seasons change, a particular region/zone in the system may lose more or less heat than other regions/zones, which may require more or less hot water to flow to that particular zone than initially allotted. Further, changes or repairs made to the system, or even the building construction, can lead to the system becoming out of balance.

Furthermore, by maintaining a relatively constant flow of water through the system irrespective of hot water temperatures in the various regions/zones, the recirculation pump and the boiler in the hot water or hydronic heating system may perform more work or operate for longer periods of time than optimally required, which can lead to a significant waste of energy.

The above information disclosed in this Background section is only for enhancement of understanding of the background of the invention and therefore it may contain information that does not form the prior art that is already known to a person of ordinary skill in the art.

### SUMMARY

Aspects of embodiments of the invention are directed toward a thermal valve for balancing the temperature of a recirculating hot water supply system or a hydronic heating system by controlling the flow of fluid through the system.

Aspects of embodiments of the invention are directed to a thermal valve (e.g., a thermal balance valve) having an actuator (e.g., a sealed expansion chamber or capsule) containing a heat-sensitive material (e.g., wax) that expands or contracts based on a fluid temperature. The actuator moves relative to a rod/piston fixed to the housing of the thermal valve to close or open the valve. The thermal valve closes in response to increasing temperature. By placing the thermal valve in a circulation path of fluid in a hot water supply system or a hydronic heating system, the thermal valve may regulate (e.g., passively regulate) the flow of fluid flow through the path based on the temperature of the fluid. As such, a hot water supply system or a hydronic heating system may maintain a substantially constant temperature by utilizing one or more thermal valves to passively control the flow of circulating fluid. Further, by utilizing one or more thermal valves in a hot water supply system or a hydronic heating system having a number of fluid circulation loops and/or zones, the system may automatically and passively maintain balance over time. The passive balancing of the system may occur in lieu of or in the presence of manual balancing adjustments to the system. Additionally, the use of the thermal valve(s) to restrict the flow of hot water at appropriate points during the operation of the hot water supply or hydronic heating system may lead to substantial energy and cost savings.

According to some embodiments of the invention, there is provided a thermal valve for controlling a flow of fluid, the thermal valve including: a housing having an inlet and an outlet configured to permit the flow of fluid through an interior of the housing; an actuator including heat-sensitive material configured to contract or expand based on a temperature of the fluid; a rod fixedly coupled to the housing and partially inside the actuator, the rod being configured to move relative to the actuator as the heat-sensitive material contracts or expands; a chamber inside the housing and fixedly coupled to the housing, the chamber being configured to accommodate the actuator; a first compressive resilient element configured to movably couple the actuator to the chamber; and a disc movably coupled to the chamber via a second compression element, and configured to permit flow of the fluid from the inlet to the outlet and to reduce flow of water from the outlet to the inlet.

In an embodiment, the actuator is configured to reduce a flow of the fluid through the thermal valve when the temperature of the fluid exceeds a closing temperature.

In an embodiment, the actuator includes a body extending along a lengthwise direction of a housing and a fin extending laterally from the body.

In an embodiment, the chamber includes a widened portion and a stem, the widened portion having a diameter greater than that of the stem.

In an embodiment, the stem is configured to receive the body of the actuator, and wherein the widened portion is configured to accommodate the fin of the actuator.

In an embodiment, the chamber has perforated walls

In an embodiment, the chamber has a flow opening, and the actuator is configured to close a gap between a fin of the actuator and the chamber at the flow opening when the temperature of the fluid exceeds a closing temperature.

In an embodiment, the first compressive resilient element is configured to maintain the fin of the actuator at a distance from the inlet when the temperature of the fluid does not exceed the closing temperature.

In an embodiment, the heat-sensitive material includes wax.

In an embodiment, the disc has a diameter greater than that of the inlet, the disc being configured to press against a seating surface of the housing and to reduce current flow when the fluid flows from the outlet to the inlet.

In an embodiment, the second compressive resilient element is configured to apply a force to the disc to press the disc against the seating surface of the housing.

In an embodiment, the disc includes a bypass hole configured to permit reduced fluid flow through the housing.

In an embodiment, the thermal valve further includes a valve flange at an outer periphery of the housing and extending substantially perpendicular to a lengthwise direction of the housing.

In an embodiment, the valve flange is coupled between a flange of a pipe and an input or an output of a pump.

In an embodiment, the housing is configured to fit within a pipe at an interface of the pipe and a pump.

In an embodiment, a lengthwise periphery of the housing is separated from an inner surface of the pipe by a gap.

According to some embodiments of the invention, there is provided a thermal valve for controlling a flow of fluid, the thermal valve including: a housing having an inlet and an outlet configured to permit the flow of fluid through an interior of the housing; a stopper inside the housing and fixedly coupled to the housing and defining a valve opening; an actuator including heat-sensitive material configured to contract or expand and to engage the stopper based on a temperature of the fluid, the actuator being further configured to reduce a flow of the fluid through the thermal valve as the temperature of the fluid decreases; a rod fixedly coupled to the housing and partially inside the actuator, the rod being configured to move relative to the actuator as the heat-sensitive material contracts or expands; a chamber inside the housing and fixedly coupled to the housing, the chamber being configured to accommodate the actuator; a first compressive resilient element configured to movably couple the actuator to the chamber; and a disc movably coupled to the chamber via a second compression element, and configured to permit flow of the fluid from the inlet to the outlet and to reduce flow of water from the outlet to the inlet.

In an embodiment, the actuator is configured to increase a gap between a fin of the actuator and the stopper at the valve opening when the temperature of the fluid exceeds an opening temperature.

In an embodiment, the first compressive resilient element is configured to maintain the fin of the actuator pressed against the stopper when the temperature of the fluid does not exceed the opening temperature.

### BRIEF DESCRIPTION OF THE DRAWINGS

The accompanying drawings, together with the specification, illustrate exemplary embodiments of the invention, and, together with the description, serve to explain aspects of embodiments of the invention. In the drawings, like reference numerals are used throughout the figures to reference like features and components. The figures are not necessarily drawn to scale. The above and other features and aspects of the invention will become more apparent by the following detailed description of exemplary embodiments thereof with reference to the attached drawings, in which:

FIGS. 1A and 1B illustrate a thermal valve, according to some exemplary embodiments of the invention; FIG. 1A is a vertical sectional view showing the interior of the thermal valve, according to some exemplary embodiments of the invention; FIG. 1B is a side view of the exterior of the thermal valve, according to some exemplary embodiments of the invention.

FIG. 2 illustrates a joint assembly integrated with a thermal valve, according to some exemplary embodiments of the invention;

FIG. 3 is a schematic diagram of a hot water supply system including the thermal valve, according to some exemplary embodiments of the invention;

FIG. 4 is a schematic diagram of a hydronic heating system including the thermal valve, according to some exemplary embodiments of the invention;

FIGS. 5A-5B illustrate a thermal valve, according to some exemplary embodiments of the invention. FIG. 5A is a vertical sectional view showing the interior of the thermal valve and a joint assembly integrated with the thermal valve, according to some exemplary embodiments of the invention; FIG. 5B is a perspective view of the thermal valve, according to some exemplary embodiments of the invention;

FIG. 5C illustrates a vertical sectional view showing the interior of a thermal valve and a joint assembly integrated with the thermal valve, according to some other exemplary embodiments of the invention; and

FIGS. 6A-6C are schematic diagrams illustrating various configurations of the thermal valve relative to the pipe and the pump in a hot water supply system or a hydronic heating system, according to some exemplary embodiments of the invention.

### DETAILED DESCRIPTION

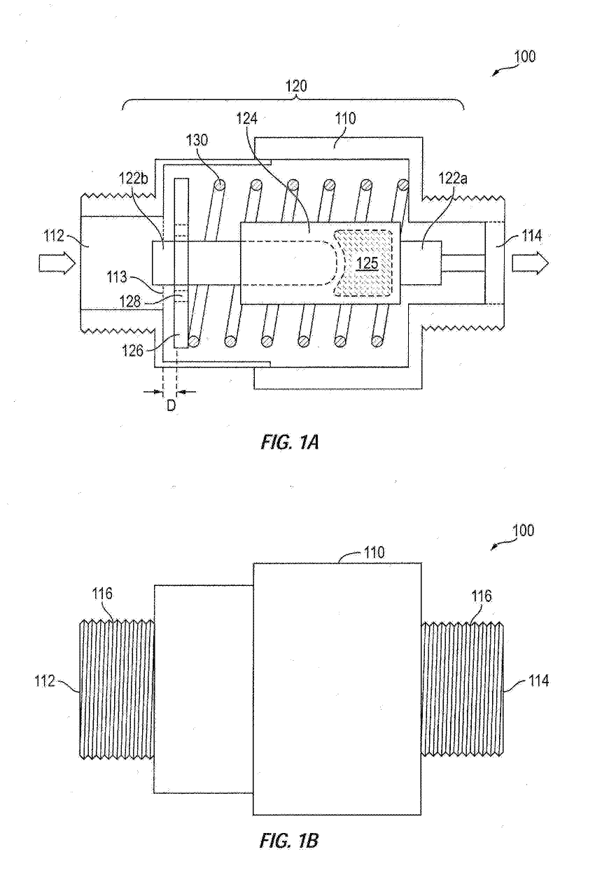

FIGS. 1A and 1B illustrate a thermal valve 100, according to some exemplary embodiments of the invention. FIG. 1A is a cutaway view of the interior of the thermal valve 100, according to some exemplary embodiments of the invention. FIG. 1B is a side view of the exterior of the thermal valve 100, according to some exemplary embodiments of the invention.

Referring to FIG. 1A, the thermal valve (e.g., thermal balance valve) 100 includes a housing 110 and a power unit 120 inside the housing 110. The housing 110 includes an inlet 112 and an outlet 114 for permitting the flow of a fluid (e.g., water) through the interior of the housing 110. The housing 110 may be coupled to a conduit of a fluid circulation system via, for example, a screw mechanism or threaded joint 116. In some embodiments, the power unit 120 is coupled to (e.g., fixedly coupled to) the housing 110 on one end through a first rod (e.g., a shaft) 122a, and coupled to (e.g., operatively coupled to) the housing 110 on another end via a second rod (e.g., a shaft or piston) 122b and a flow control disc 126 fixedly attached to the second rod 122b.

A compressive element (e.g., a spring) 130 couples the flow control disc 126 to the interior of the housing 110 and maintains the flow control disc 126 at a default position. The flow control disc 126 has a diameter that is larger than a diameter of the inlet opening 113 to stop or reduce the flow of fluid through the housing 110 when pressed against the inlet opening 113.

In some embodiments, the flow control disc 126 is maintained in a default position, which is at least at a distance D from the inlet opening 113. Thus, when in the default position, a gap exists between the flow control disc 126 and the inlet opening 113 allowing fluid to pass through the thermal valve 100. The compressive element 130 allows the flow control disc 126 to move relative to the inlet opening 133 in response to pressure changes in the inflow of fluid. Thus, the thermal valve 100 may accommodate higher fluid pressure by increasing the gap D and permitting a greater flow of fluid through the thermal valve 100, and may accommodate lower fluid pressure by decreasing the gap D and reducing the flow of fluid.

According to some embodiments, the actuator 124 contains heat-sensitive material (e.g., a wax pellet) 125. As the temperature of the fluid surrounding the actuator 124 increases, the heat-sensitive material 125 undergoes a solid to liquid transition, which is accompanied by an increase in volume of the heat-sensitive material 125. The expansion of the heat-sensitive material pushes the second rod (e.g., piston) 122b in a direction away from the first rod 122a, thus driving the flow control disc 126 toward the inlet opening 133 and reducing the fluid flow through the inlet 112. At a predetermined temperature, the heat-sensitive material 125 expands to a point that the flow control disc 126 is fully pressed against the inlet opening 113, thus sealing the opening 113 and stemming the flow of fluid through the thermal valve (and thereby completely shutting off the valve). In one example, the actuator 124 may include thermally conductive materials such as brass to make the thermal valve 100 more responsive (e.g., more sensitive) to fluid temperature changes.

The heat-sensitive material 125 may include refined hydrocarbons, vegetable matter extracts, metal particles, synthetic polymers, and/or the like. In one example. The heat-sensitive material 125 may include paraffin wax. The composition of the heat-sensitive material 125 may be chosen such that the heat-sensitive material 125 actuates the flow control disc 126 to close the thermal valve 100 at a desired temperature. In one example, the closing temperature may be about 105° F. or about 110° F. In other examples, the closing temperature may in a range between about 120° F. and about 200° F.

In one embodiment, the flow control disc 126 includes one or more bypass holes 128 to provide a small fluid bypass path even when the thermal valve 100 is closed.

Referring to FIG. 1B, the ends of the inlet 112 and outlet 114 may be threaded to couple to threaded pipes of the circulation conduit. In one example tapered threats (such as those conforming to the national pipe thread taper (NPT)) may be used to form a seal when the inlet 112 and outlet 114 are coupled to the circulation conduit.

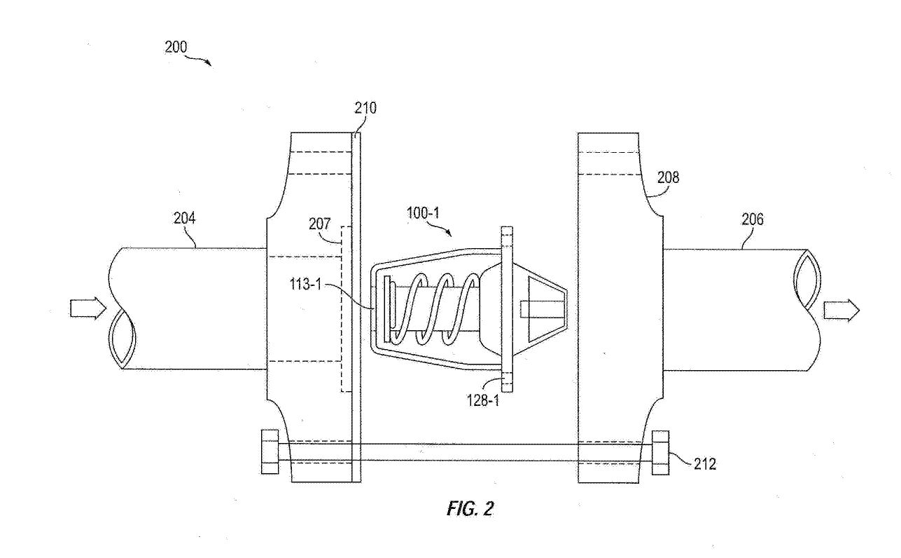

FIG. 2 illustrates a joint assembly 200 integrated with a thermal valve 100-1, according to some embodiments of the invention.

In one embodiment, the joint assembly 200 includes an inlet pipe 202 and an outlet pipe 204, a pair of flanges 208 coupled to the inlet and outlet pipes 204 and 206, a rubber gasket 210 between the pair of flanges 208 and creating a sealed chamber within which the thermal valve 100-1 is integrated. The flanges 208 and the rubber gasket may be held together in compression by a fastening mechanism 212, which may include two or more nuts and bolts. The thermal valve 100-1 may be similar in structure to the thermal valve 100 described above with respect to FIGS. 1A and 1B. The thermal valve 100-1 may fit within one or more grooves 207 within one or more of the flanges 208. The diameter of the inlet opening 113-1 of the thermal valve 100-1 may be smaller than the diameter of the inlet pipe 204. For example, the inlet pipe may be a standard 1 inch pipe, while the inlet opening may be ⅞ inch wide.

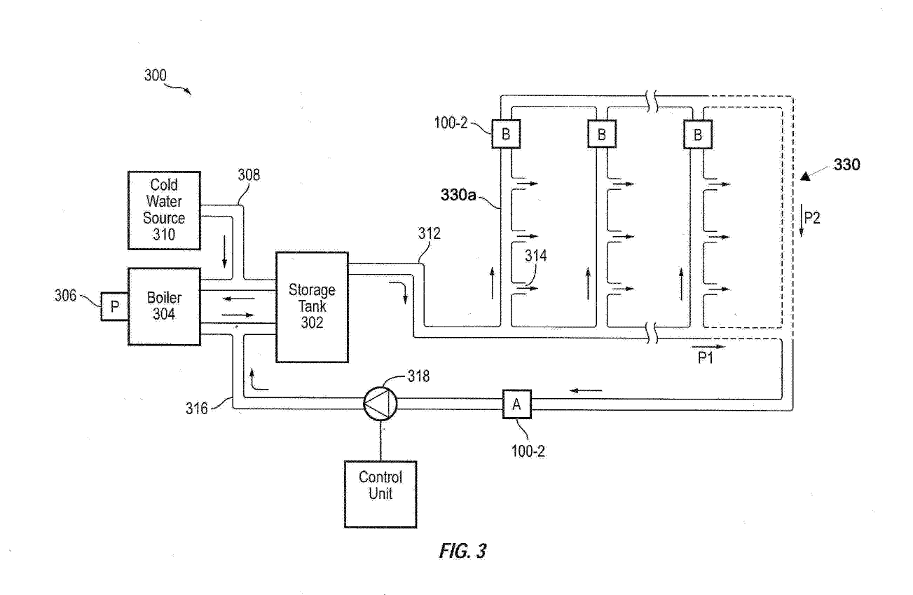

FIG. 3 is a schematic diagram of a hot water supply system 300 including the thermal valve 100-2, according to some exemplary embodiments of the invention.

According to some embodiments, the hot water supply system (e.g., a domestic/recirculating hot water supply system) 300 includes a storage tank 302, a boiler (e.g., water heater) 304, an aquastat 306 for controlling and maintaining the water temperature at the boiler 304 and/or storage tank 302, a cold water conduit 308 for providing cold water to the recirculation system from a cold water source 310, a supply conduit 312 for supplying hot water to one or more water outlets (e.g., taps) 314, a return conduit 316 for returning water to the storage tank 302, a pump (e.g., a circulation pump) 318 for circulating the water from the storage tank 302 to the one or more water outlets 314, and one or more thermal valves 100-2. The arrows along the conduits are indicative of the direction of water flow in the recirculation hot water supply system.

In some embodiments, the storage tank 302 includes an integrated water heater instead of the separate boiler 304.

In some embodiments, the hot water supply system 300 includes one or more loops 330 having a series of water outlets 314 for user consumption of hot water. In an example, each loop represents a riser in a multi-story building, and each water outlet 314 supplies water to a living unit. In an example, the water outlets 314 may be shower heads, faucets, etc. In some examples, the return path of each of the loops 330 may be through path P1 and/or through path P2.

In some embodiments, a thermal valve 100-1 may be placed in position A along the return conduit 316, which may be close to the storage tank 302. Position A may be before or after the pump 318 along the return path.

In some embodiments, the heat-sensitive material (e.g., wax) within the thermal valve 100-2 may be selected such that the closing temperature of the thermal valve 100-2 (i.e., the temperature at which the heat-sensitive material inside the thermal valve 100-2 expands and closes the valve 100-2) is about the same as or slightly below a preselected setpoint temperature of the hot water supply system 300. For example, when the preselected setpoint temperature (e.g., the desired temperature at which the hot water is desired to be maintained) is about 110° F., a thermal valve 100-2 having a closing temperature of 105° F. or 110° F. may be employed.

In one exemplary scenario, when demand for hot water is high, the storage tank 302 may not be able to supply enough hot water to satisfy the users' water needs and, as a result, the temperature of the water along the return path (i.e., the return temperature) may drop well below the setpoint temperature. In another exemplary scenario, a loop 330 may be losing more heat than expected (e.g., as a result of cold environmental temperatures, poor insulation, leakage, etc.) causing the temperature along the return path to be below the setpoint temperature. Thus, the return temperature (e.g., the temperature of water along the return conduit 316) may be below the closing temperature of the thermal valve 100-2. In such a case, the heat-sensitive material inside the thermal valve may be in a contracted solid state and the thermal valve 100-2 may be in an open state (e.g., the default state of the thermal valve 100-2) allowing water to freely flow through the return conduit 316 and to the storage tank 302. The boiler 304 heats the water at the storage tank 302 in order to increase the water temperature up to the setpoint temperature.

As the water temperature approaches the setpoint temperature, the water temperature may exceed the closing temperature of thermal valve 100-2, causing the heat-sensitive material therein to expand and close the thermal valve 100-2. When the thermal valve 100-2 closes, the circulation of water in the hot water supply system 300 may cease or may become very small (e.g., as may occur when the thermal valve 100-2 has one or more bypass holes as described above with respect to FIGS. 1A-1B and 2). This may lead to substantial energy savings because circulating less water through the system uses less electrical energy at the circulation pump 318 and less energy at the boiler 304.

In some embodiments, each loop 330 of the hot water supply system 300 includes a thermal valve 100-2. For example, a riser 330a may include a thermal valve 100-2 in position B. As such, in a multi-loop system, the flow of water through each of the loops 330 is separately and passively controlled.

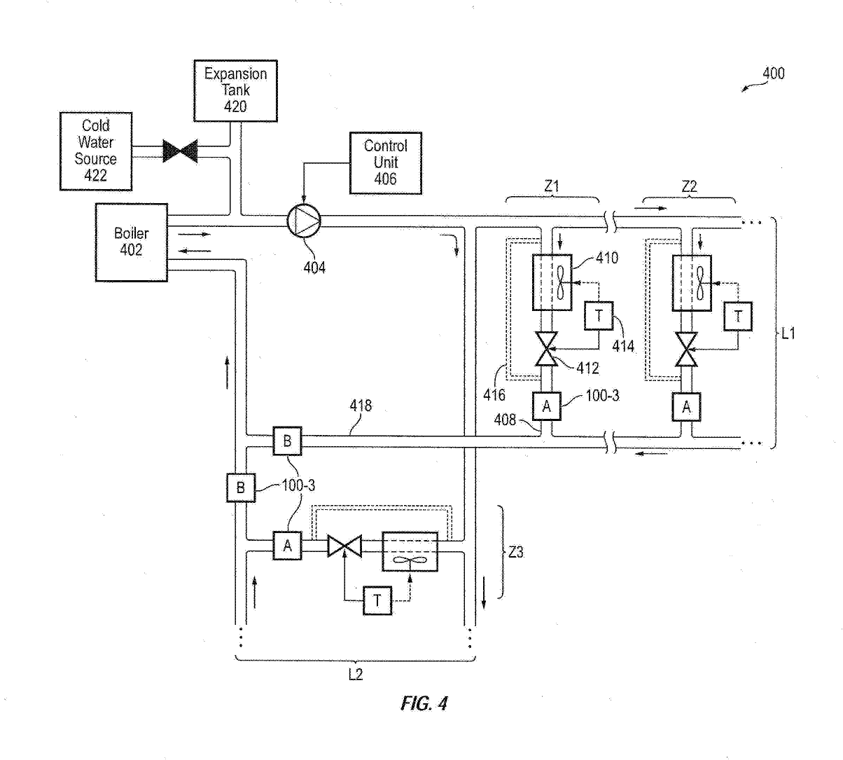

FIG. 4 is a schematic diagram of a hydronic heating system 400 including the thermal valve 100-3, according to some exemplary embodiments of the invention.

According to some embodiments, the hydronic heating system (e.g., the closed-loop domestic hydronic heating system) 400 includes a boiler 402, a pump (e.g., circulation pump) 404 for pumping a heating fluid (e.g., water) through the system 400, a control unit 406 for controlling the on/off state and/or speed of the pump 404, one or more loops (such as loops A and B), and one or more thermal valves 100-3. A thermal valve 100-3 may be similar in structure to the thermal valve 100 described above with respect to FIGS. 1A and 1B. The arrows along the conduits are indicative of the direction of flow of the heating fluid within the hydronic heating system 400.

Each loop may represent a building or a section of a building and may be divided into a number of zones (such as zones Z1, Z2, and Z3), which may represent, for example, different floors, rooms, and/or offices.

Each zone may include a zone pipe 408 for carrying hot fluid from the boiler 402 to the zone, a terminal unit (e.g., a fan coil, radiator, heat pump, etc.) 408 for extracting thermal energy from the zone pipe 408 and providing heat to the corresponding zone, a zone valve 412 for allowing/stopping the flow of water through the zone pipe 408, and a thermostat 414 for controlling the zone valve 412. In an example, when the thermostat 414 detects that the zone temperature has reached the set point (e.g., 70° F.), the thermostat closes the zone valve 412 to prevent further flow of heating fluid through the zone pipe 408. The thermostat may also control the state (e.g., on/off state) of the terminal unit 410. In some embodiments, each zone may also include a bypass path 416 to allow limited flow of heating fluid through the zone even when the zone valve 412 is closed.

In some embodiments, each zone also includes a thermal valve 100-3 for controlling the flux of heating fluid through the zone based on the temperature of the heating fluid. For example as the temperature of the heating fluid flowing through the zone pipe 408 increases to approach a desired temperature (e.g., 160° F.), the thermal valve 100-3 reduces the flow of heating fluid through the zone pipe 408 and shuts off the flow or substantially reduces the flow (e.g., in some embodiments in which the thermal valve 100-3 has one or more bypass holes) when the fluid temperature reaches the desired point. The thermal valve 100-3 operates passively and independently from the zone valve 412. The thermal valve 100-3 may be positioned at any point along the zone pipe 408, for example, at position A shown in FIG. 4. In some embodiments in which each of the zones has a dedicated thermal valve 100-3 (as shown in FIG. 4), the flow of heating fluid through each of the zones is independently and passively adjusted and, as a result, the loop is automatically and passively balanced.

According to some embodiments, each loop may have a thermal valve 100-3 at a position along the return conduit 418 of the loop (e.g., at position B shown in FIG. 4) in addition to, or in lieu of, the dedicated thermal valves 100-3 at each of the zones in the loop.

In an example, hydronic heating system 400 further includes an expansion tank 420 to accommodate for the expansion of the heating fluid as its temperature rises and to stabilize the fluid pressure in the system. The hydronic heating system 400 may further include a cold water source 422 for compensating any fluid loss (e.g., fluid leakage) through the closed loop system.

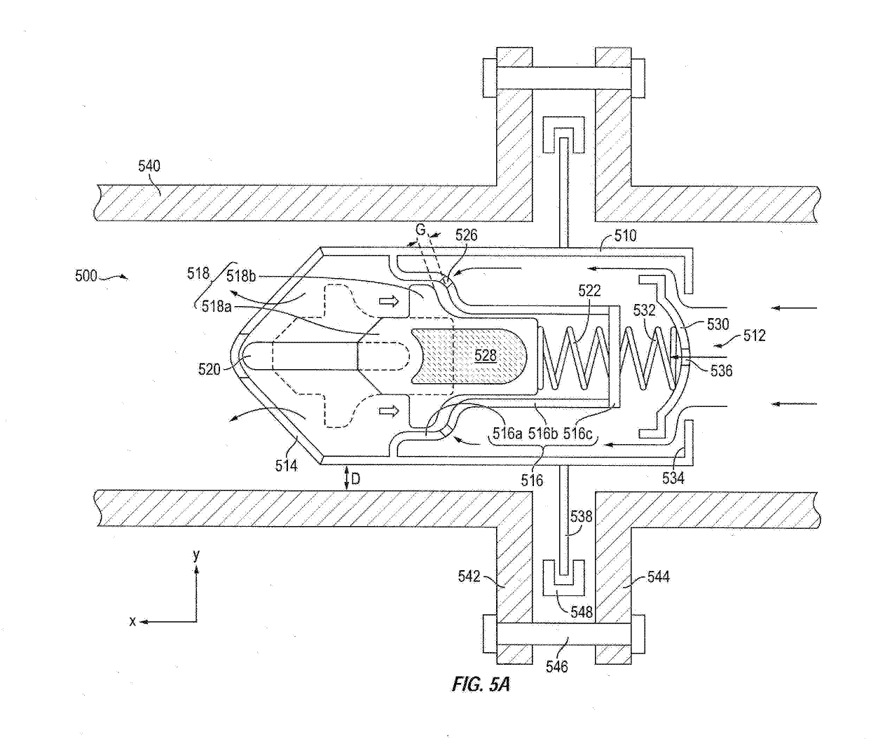

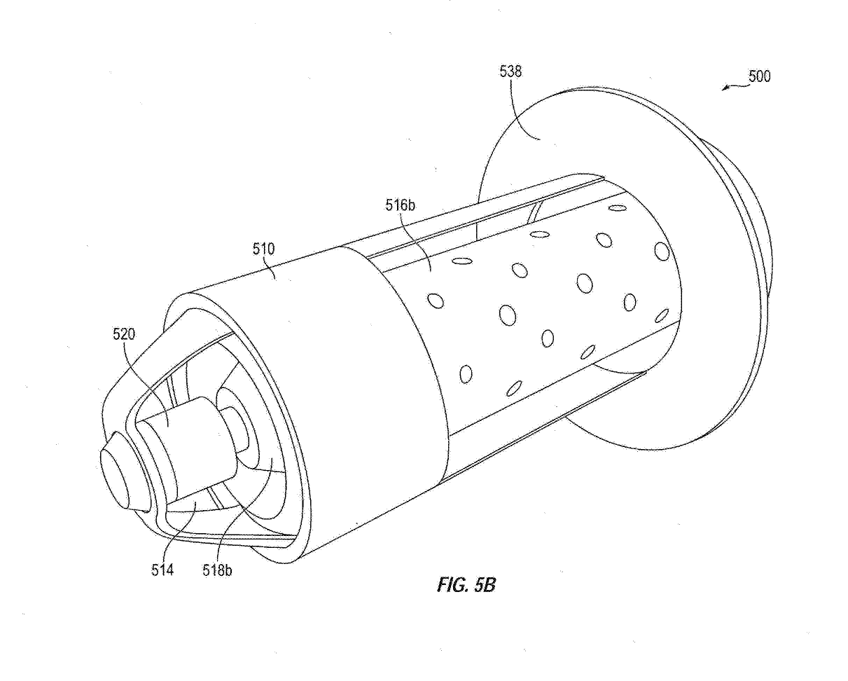

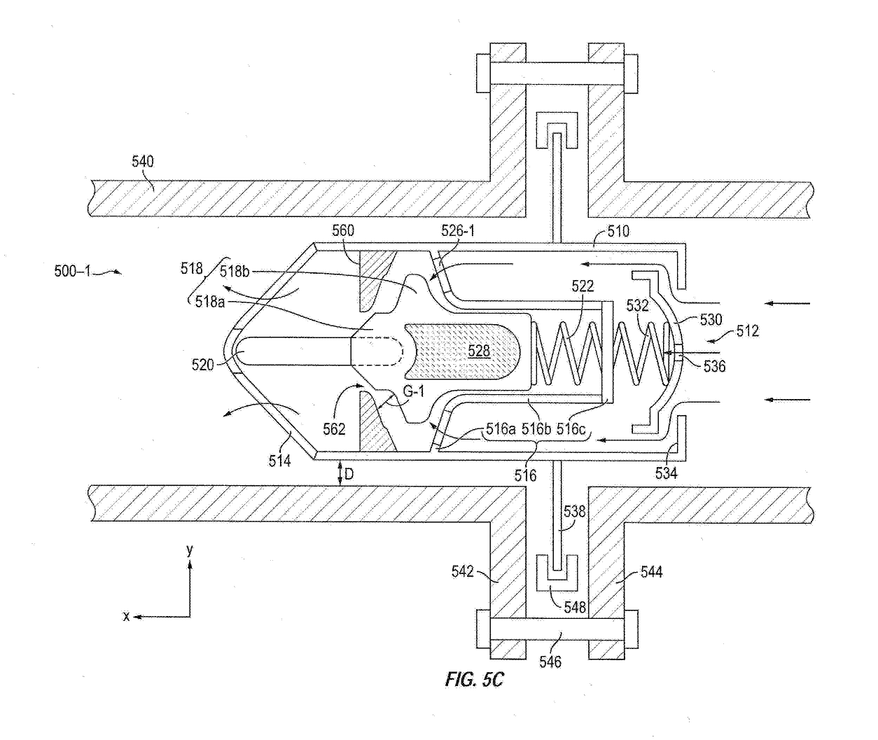

FIGS. 5A-5B illustrate a thermal valve 500, according to some exemplary embodiments of the invention. FIG. 5A is a vertical sectional view showing the interior of the thermal valve 500 and a joint assembly integrated with the thermal valve 500, according to some exemplary embodiments of the invention; and FIG. 5B is a perspective view of the thermal valve 500, according to some exemplary embodiments of the invention.

Referring to FIG. 5A, the thermal valve (e.g., thermal balance valve) 500 includes a housing 510 having an inlet (e.g., inlet opening) 512 and an outlet (e.g., outlet opening) 514 for permitting the flow of a fluid (e.g., water) through the interior of the housing 510. The housing 510 may be coupled to a conduit of a fluid circulation system via, for example, a screw mechanism or a threaded joint. In some embodiments, the thermal valve 500 further includes a chamber 516 that is coupled to (e.g., fixedly coupled to) the housing 510, an actuator (e.g., a sealed expansion chamber or capsule) 518 that is coupled to (e.g., operatively coupled to) the housing 510 on one end via a rod (e.g., a shaft or piston) 520 and to the chamber 516 on an other end through a first compressive resilient element 522. The rod 520 may be fixedly coupled to the housing 510.

The actuator 518 includes a body 518a extending along a lengthwise or axial direction of a housing (e.g., along the X direction) and a fin (e.g., a rim portion) 518b extending laterally or radially from the body 518a (e.g., generally along the Y direction). In some examples, the actuator 518 has radial symmetry along a central axis (e.g., along in the X direction); however, embodiments of the invention are not limited thereto, and the actuator 518 may have any suitable shape.

The chamber 516 is configured to accommodate the actuator 518. The chamber 516 includes a widened portion 516a, a stem 516b, and a base 516c. The stem 516b may be shaped to receive the body 518a of the actuator 518 and to allow the actuator 518 to move in a lengthwise direction of the housing 510 (e.g., in the X direction) within the chamber 516 (e.g., within the stem 516b of the chamber 516). The widened portion 516a of the chamber 516 may be shaped to accommodate the fin 518b of the actuator 518. In some examples, the stem 516b may be cylindrical in shape, and the widened portion 516a may be tapered or bowl-shaped, and be generally wider (e.g., have a greater diameter) than the stem 516b. While in some embodiments, the chamber 516 may have radial symmetry along a central axis (e.g., in the X direction), embodiments of the invention are not limited thereto, and the chamber 516 may have any suitable shape.

The actuator 518 is coupled to the chamber 516 (e.g., the base 516c) via a first compressive resilient element (e.g., a first spring) 522. The first compressive resilient element 522 may apply a restoring force to the actuator 518 to create a gap G between the fin 518b of the actuator 518 and the interior of the widened portion 516a when the first compressive resilient element 522 is in a relaxed state (i.e., not a compressed state). The fin 518b may fit within, and contact, the widened portion 516a when the first compressive resilient element 522 is in a compressed state. For example, the contours of the portions of the fin 518b and the widened portion 516a facing (and contacting) one another may substantially match.

In some embodiments, the walls of the widened portion 516a of the chamber 516 have one or more flow openings 526 that permit fluid to flow from the inlet 512 to the outlet 514 when a gap G exists between the fin 518b of the actuator 518 and the inner wall of the widened portion 516a. As the gap G between the fin 518b and widened portion 516a decreases, the flow of fluid through the flow openings 526 (and hence the housing 510) is reduced until the gap G closes, at which point the flow may be stemmed completely (or at least significantly reduced). Thus, designing the thermal valve 500 to have a larger gap G when the thermal valve 500 is in a default open state (or cold state) allows the thermal valve 500 to accommodate higher fluid pressure and permit greater fluid flow. Decreasing the gap G will have an opposite effect. The size of the gap G may be based on, for example, the stiffness of the first compressive resilient element 522 and the geometrical dimensions of the chamber 516 and actuator 518. As used herein the default open state (or cold state) refers to a state in which the thermal valve is maximally open and permits maximum fluid flow.

According to some embodiments, the actuator 518 contains heat-sensitive material (e.g., a wax pellet) 528. As the temperature of the fluid surrounding the actuator 518 increases, the heat-sensitive material 528 undergoes a solid to liquid transition, which is accompanied by an increase in volume of the heat-sensitive material 528. The expansion of the heat-sensitive material 528 pushes the actuator 518 in a direction away from the rod 520 (which is fixed to the housing 510), thus driving the fin 518b of the actuator 518 toward the one or more flow openings 526 of the widened portion 516a, and reducing the fluid flow through the inlet 512. At a predetermined temperature, the heat-sensitive material 528 expands to a point that the fin 518b is fully seated against the one or more flow openings 526, thus sealing the one or more flow openings 526 and stemming the flow of fluid through the thermal valve 500 (and thereby completely closing or shutting off the valve). In one example, the actuator 518 may include thermally conductive materials, such as brass, copper, stainless steel, to make the thermal valve 500 more responsive (e.g., more sensitive) to changes in fluid temperature. In examples in which the fluid flowing through the thermal valve 500 is corrosive to metal (e.g., when the fluid includes a brine solution), the actuator 518 may include (e.g., be coated with) one or more materials resistant to corrosion, such as suitable plastic material, and or the like.

In some embodiments, the heat-sensitive material 528 may be substantially similar to the heat-sensitive material 125 and may be chosen such that the heat-sensitive material 528 closes the thermal valve 500 at a desired temperature. In one example, the closing temperature may be about 105° F. to about 110° F. In other examples, the closing temperature may in a range between about 120° F. and about 200° F. However, embodiments of the invention are not limited thereto. For example, in a high-pressure hot water system, the closing temperature may as high as 300° F. or higher. Further, in examples, in which the fluid flowing through the thermal valve 500 has a low freezing temperature (e.g., when the fluid includes a refrigerant, such as Freon), the closing temperature may be as low as −40° F. or lower.

According to some embodiments, the thermal valve 500 further includes a disc 530 at the inlet 512 that is coupled (e.g., movably coupled) to the chamber 516 (e.g., to the base 516c) via a second compressive resilient element (e.g., a second spring) 532.

The disc 530 has a diameter larger than a diameter of the inlet 512 to stop or reduce the flow of fluid through the housing 510 when pressed against the inlet 512 (e.g., against the seating surface 534). The second compressive resilient element 532 is configured to press or urge the disc 530 against a seating surface 534 of the interior of the housing 510 when there is no fluid passing through the inlet 512. This may represent the disc's default position. When the exterior fluid pressure at the inlet 512 exceeds the internal fluid pressure of the housing 510 near the inlet 512, the second compressive resilient element 532 compresses to permit for the passage of fluid through the housing 510 from the inlet 512 to the outlet 514.

When the fluid pressure differential is reversed (i.e., the internal fluid pressure of the housing 510 near the inlet 512 exceeds the external fluid pressure at the inlet 512), the effects of the pressure differential and the restorative force of the second compressive resilient element 532 add constructively to cause the disc 530 to press against the seating surface 534 of the housing 510. Thus, the disc 530, the second compressive resilient element 532, and the housing 510 act together to function as a check valve that permits fluid to flow from the inlet 512 to an outlet 514, but prevents (or substantially reduces) back flow, that is, flow from the outlet 514 of the thermal valve 500 to the inlet 512.

In one embodiment, the disc 530 includes one or more bypass openings 536 to provide a small fluid bypass path even when the disc 530 is pressed against the seating surface 534 to reduce backflow of fluid. Permitting a small amount of backflow through the system even when the thermal valve 500 is closed, and thereby preventing a complete cessation of fluid flow through the system (i.e., preventing the fluid to stagnate at the thermal valve 500), allows the thermal valve 500 to be more responsive to (e.g., respond more quickly and accurately to) fluid temperature changes.

In some embodiments, the first compressive resilient element 522 may have a higher stiffness than the second compressive resilient element 532.

In some examples, the disc 530 may have a convex surface (e.g., a bump) protruding toward the inlet 512 to improve fluid dynamics through the inlet 512 and around the disc 530. However, embodiments of the invention are not limited thereto, and the disc 530 may be, for example, substantially flat.

As shown in FIG. 5B, the outer profile of the housing 510 may be configured to match the profile of the inner surface of the pipe 540 within which the thermal valve 500 is placed. For example, the housing 510 may be substantially cylindrical. In some examples, the peripheral wall of the chamber 516 may be perforated. The perforations may allow more fluid to flow through the chamber 516 (and thus, through the thermal valve 500) when the thermal valve in an open state.

In some examples, the width (or diameter) of the thermal valve 500 may be less than the inner diameter of the pipe 540 such that there is a gap (e.g., a clearance) D between the outer periphery of the housing 510 and the inner side of the pipe 540. The gap D serves to thermally isolate the thermal valve 500 from the pipe 540, and therefore from the ambient temperature (e.g., air temperature) external to the pipe 540. As the gap D increases, the temperature experienced by the heat-sensitive material 528 may be less influenced by the ambient temperature and be more representative of (e.g., closer to) the actual temperature of the fluid flowing through the pipe 540. However, increasing the gap D may also limit the flow of fluid through the thermal valve 500; therefore, in embodiments of the invention, the gap D is chosen to balance thermal isolation against fluid flow. The value of gap D may also depend on the volume of fluid that is circulated through the system. For example, the gap D may be about 0.25 inches to about 3 inches. However, embodiments of the invention are not limited thereto and the width of the thermal valve 500 may be designed such that the thermal valve 500 fits snuggly within the pipe 540. The material and/or volume of the heat-sensitive material 528 within the actuator 518 may be chosen to take into account the actuator's level of thermal isolation from the ambient temperature for a given gap D and a desired closing temperature.

According to some embodiments, the thermal valve 500 further includes a valve flange 538 attached to the outer periphery of the housing 510 and extending laterally (e.g., along the Y direction) from the length of the housing 510 (which extends in, e.g., the X direction). In some embodiments, the valve flange 538 is substantially circular or disc-like in shape and may extend all the way around the periphery of the housing 510; however, embodiments of the invention are not limited thereto. For example, the valve flange 538 may be oval in shape or may be in the form of protrusions or wings extending outward from the housing 510.

The valve flange 538 may be used to maintain the thermal valve 500 in a fixed position within the pipe 540. In some embodiments, the valve flange 538 is coupled to the pipe 540 by being sandwiched between the first and second flanges 542 and 544 using, for example, a fastening mechanism 546 and a washer 548, which may form a joint seal at the interface of the first and second flanges 542 and 544.

When the valve flange 538 is fixed to pipe 540, the valve flange 538 may block fluid flow in the gap D between the outer periphery of the housing 510 and the inner surface of the pipe 540 facing the housing 510. As a result, fluid flow within the pipe 540 may entirely pass through the thermal valve 500 (e.g., only through the inlet 512).

FIG. 5C illustrates a thermal valve 500-1, according to some exemplary embodiments of the invention. FIG. 5C is a vertical sectional view showing the interior of the thermal valve 500-1 and a joint assembly integrated with the thermal valve 500-1, according to some exemplary embodiments of the invention. As the thermal valve 500-1 is substantially similar in structure and operation to the thermal valve 500, a description of common elements and operations will not be repeated hereinafter.

Referring to FIG. 5C, a primary difference between the thermal valves 500 and 500-1 is that the thermal valve 500-1 is designed to open (rather than close) as the fluid temperature rises above a set or predetermined temperature (hereinafter, “opening temperature”).

In some embodiments, the thermal valve 500-1 includes a stopper 560 fixedly coupled to the housing 510. The actuator 518 may be positioned between (and engage) the stopper 560 and the chamber 516. The chamber 516 may be fixedly coupled to the housing 510 at the widened portion 516a. The widened portion 516a may have one or more flow openings 526-1 that permit fluid to flow from the inlet 512 to the outlet 514 when the thermal valve 500-1 is in an open state.

According to some embodiments, the heat-sensitive material 528 expands (e.g., undergoes a solid to liquid transition) as the temperature of the fluid surrounding the actuator 518 increases (e.g., increases above the opening temperature), thus pushing the actuator 518 in a direction away from the stopper 560 (e.g., along the -X direction shown in FIG. 5C) exposing the valve opening 562 and creating a gap G-1 between the fin 518b of the actuator 518 and the inner wall of the stopper 560. As a result, fluid may flow from the inlet 512, through the valve opening 562, to the outlet 514.

As the gap G-1 between the fin 518b and stopper 560 increases, the flow of fluid through the valve opening 562 (and hence the housing 510) increases. Designing the thermal valve 500-1 to have a larger gap G-1 when the thermal valve 500 is in an open state (or in a hot state) allows the thermal valve 500 to accommodate higher fluid pressure and permit greater fluid flow. Decreasing the gap G will have an opposite effect. The size of the gap G may be based on, for example, the stiffness of the first compressive resilient element 522 and the geometrical dimensions of the chamber 516 and actuator 518. As used herein the open state (or the hot state) refers to a state in which the thermal valve is maximally open and permits maximum fluid flow.

In some embodiments, as the fluid temperature drops, the heat-sensitive material 528 in the actuator 518 contracts (e.g., transitions from a liquid state to a solid state) and the restoring force of the first compressive resilient element 522 drives the fin 518b of the actuator 518 toward the stopper 560. At a point (e.g., when the fluid temperature drops below the opening temperature), the fin 518b may be fully seated against the stopper 560, thus sealing the valve opening 562 and stemming the flow of fluid through the thermal valve 500 (and thereby completely closing or shutting off the valve). This is referred to as the closed (or cold) state of the thermal valve 500-1.

The stopper 560 may be shaped to accommodate the fin 518b of the actuator 518. In some examples, the contours of the surface of the stopper (e.g., protrusion or opening lip) 560 facing the actuator 518 may correspond to (e.g., substantially match) that of the respective surface of actuator 518; however embodiments of the present invention are not limited thereto, and the facing surfaces of the stopper 560 and the actuator 518 may have any suitable shape.

In some examples, the stopper 560 has radial symmetry along a central axis (e.g., along in the X direction); however, embodiments of the invention are not limited thereto, and the stopper 560 may have any suitable shape

The outer profile of the thermal valve 500-1 may be the same or substantially the same as that if the thermal valve 500.

In some example, the opening temperature may be about −40° F. to about 100° F. However, examples are not limited thereto, and the opening temperature may be any temperature suitable for a cooling application.

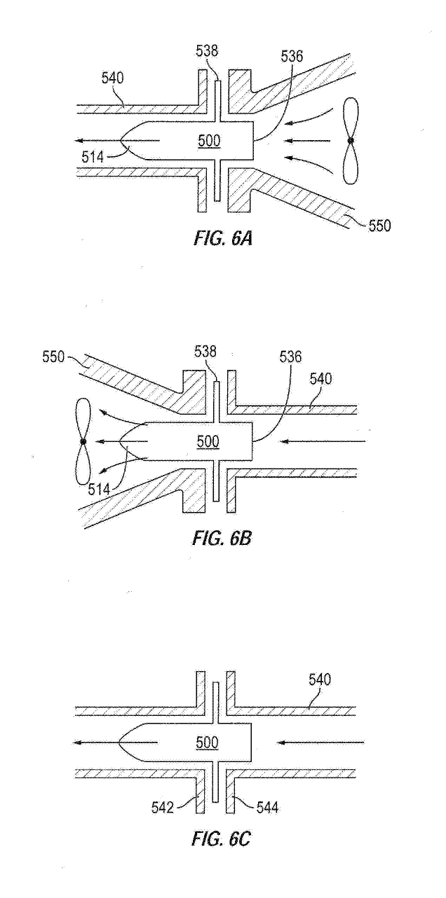

FIGS. 6A-6C are schematic diagrams illustrating various configurations of the thermal valve 500/500-1 relative to the pipe 540 and the pump 550 in a hot water supply system or a hydronic heating system, according to some exemplary embodiments of the invention.

Referring to FIG. 6A, the thermal valve 500/500-1 may be positioned at the output of the pump 550 with the inlet 512 facing the output of the pump (e.g., a circulation pump) 550. That is, the valve flange 538 may be coupled between a flange of the pipe 540 and the outlet of the pump 550. Thus, the fluid output from the pump 550 passes through the thermal valve 500/500-1 before reaching the pipe 540.

Referring to FIG. 6B, the thermal valve 500/500-1 may be positioned at the input of the pump 550 with the outlet 514 facing the input of the pump 550. That is, the valve flange 538 may be coupled between a flange of the pipe 540 and the inlet 512 of the pump 550. Thus, the fluid flowing from the pipe 540 passes through the thermal valve 500/500-1 before reaching the pump 550.

Having the thermal valve 500/500-1 positioned at the interface between the pump 550 and the pipe 540, as shown in FIGS. 6A-6B, improves the serviceability (and cost thereof) of the thermal valve 500/500-1, as the interface between the pump 550 and the pipe 540 is typically in an area that is easy to reach and operate at by a service person (e.g., as opposed to a middle of a pipe 540, which may be within a wall). Furthermore, as the pump may be turned off to stop fluid flow through the pipe 540 to allow the pipe 540 to be separated from the pump 550 prior to servicing the thermal valve 500/500-1, additional valves are not required at each end of the thermal valve 500/500-1 to achieve flow stoppage, which further simplifies the servicing process and reduces the cost of initial installation of the thermal valve 500/500-1 within a hot water supply system.

In embodiments in which the thermal valve 500/500-1 is fixed at the interface of the pipe 540 and the pump 550, because the thermal valve 500/500-1 may be far from the user's point of access in the system (e.g., the taps within the hot water supply system or the zones in a hydronic heating system), the threshold temperature of the heat-sensitive material 528 may be adjusted to account for temperature drop from the pump 550 to the point of access (e.g., as the examples of FIG. 6A) or from the point of access to the pump 550 (e.g., as in the examples of FIG. 6B).

As illustrated in FIG. 6C, the thermal valve 500/500-1 may also be positioned at a point along a pipe 540 that is away from the pipe-pump interface. In such embodiments, the valve flange 538 may be coupled between first and second flanges 542 and 544 of the pipe 540.

While FIGS. 5A, 5C, and 6A-6B illustrate a single thermal valve 500/500-1 within a pipe 540, according to some embodiments of the invention, a plurality of thermal valves 500/500-1 may be positioned in parallel within the pipe 540. For example, the plurality of thermal valves 500/500-1 may be coupled together through a disc, which may also act as a flange coupling the plurality of thermal valves 500/500-1 to the pipe 540.

As will be understood by a person of ordinary skill in the art, while the hot water supply system 300 (see, e.g., FIG. 3) and hydronic heating system 400 (see, e.g., FIG. 4) were described above with reference to the thermal valves 100-2 and 100-3, respectively, both systems 300 and 400 may readily utilize the thermal valve 500. Thus, a repeat description of the hot water supply system 300 and hydronic heating system 400 utilizing the thermal valve 500 will not be provided.

In some embodiments, the thermal valve 500 may be placed at the input or output of each of the pump 318 (of the hot water supply system 300) or pump 404 (of the hydronic heating system 400) at the interface between the respective pump 318 or 404 and the corresponding pipe end connected thereto. However, embodiments of the invention are not limited thereto, and the thermal valve 500 me be positioned, for example, at any of the locations marked “A” or “B” in FIGS. 3 and 4, or at any other suitable location as recognized by a person of ordinary skill in the art.

According to some embodiments, the thermal valve 500-1 may be utilized in a cooling system, such as an air conditioning system. The cooling system may be substantially similar to the hydronic heating system 400 illustrated in FIG. 4, with the exception that the cooling system may utilize a chiller in place of the boiler 400, and utilize the thermal valve 500 in place of the thermal valves 100-2 and 100-3.

It will be understood that, although the terms “first”, “second”, “third”, etc., may be used herein to describe various elements, components, regions, layers and/or sections, these elements, components, regions, layers and/or sections should not be limited by these terms. These terms are used to distinguish one element, component, region, layer or section from another element, component, region, layer or section. Thus, a first element, component, region, layer or section discussed below could be termed a second element, component, region, layer or section, without departing from the spirit and scope of the inventive concept.

In addition, it will also be understood that when a layer is referred to as being “between” two layers, it can be the only layer between the two layers, or one or more intervening layers may also be present.

The terminology used herein is for the purpose of describing particular embodiments and is not intended to be limiting of the inventive concept. As used herein, the singular forms “a” and “an” are intended to include the plural forms as well, unless the context clearly indicates otherwise. It will be further understood that the terms “include,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Expressions such as “at least one of,” when preceding a list of elements, modify the entire list of elements and do not modify the individual elements of the list. Further, the use of “may” when describing embodiments of the inventive concept refers to “one or more embodiments of the inventive concept.” Also, the term “exemplary” is intended to refer to an example or illustration.

It will be understood that when an element or layer is referred to as being “on”, “connected to”, “coupled to”, or “adjacent to” another element or layer, it can be directly on, connected to, coupled to, or adjacent to the other element or layer, or one or more intervening elements or layers may be present. When an element or layer is referred to as being “directly on,” “directly connected to”, “directly coupled to”, or “immediately adjacent to” another element or layer, there are no intervening elements or layers present.

As used herein, the term “substantially,” “about,” and similar terms are used as terms of approximation and not as terms of degree, and are intended to account for the inherent variations in measured or calculated values that would be recognized by those of ordinary skill in the art.

As used herein, the terms “use,” “using,” and “used” may be considered synonymous with the terms “utilize,” “utilizing,” and “utilized,” respectively.

In the following examples, the x-axis, the y-axis and the z-axis are not limited to three axes of the rectangular coordinate system, and may be interpreted in a broader sense. For example, the x-axis, the y-axis, and the z-axis may be perpendicular to one another, or may represent different directions that are not perpendicular to one another.

What is claimed is:

1. A hydronic heating system comprising:
a supply conduit configured to remove a fluid from a boiler, the boiler being configure to heat the fluid;
a return conduit configured to return the fluid to the boiler; and
a first zone comprising:
a first zone pipe fluidically coupled to the supply and return conduits and configured to carry fluid from the boiler;
a first terminal unit coupled to the first zone pipe and configured to extract thermal energy from the first zone pipe and to provide heat to a first space corresponding to the first zone; and
a first thermal valve located along the first zone pipe and configured to passively regulate a flux of fluid through the first zone pipe by reducing the flux of fluid as a temperature of the fluid rises.

2. The hydronic heating system of claim 1, wherein the fluid is water.

3. The hydronic heating system of claim 1, wherein the first thermal valve comprises a heat-sensitive material configured to expand and close the first thermal valve when water when the temperature of the water exceeds a closing temperature, and to contract and open the first thermal valve when the temperature of the water is below the closing temperature.

4. The hydronic heating system of claim 1, further comprising:
a circulation pump located along the supply conduit or return conduit, and configured to pump the fluid through the supply and return conduits; and
a control unit for controlling an on/off state and/or a speed of the circulation pump.

5. The hydronic heating system of claim 1, further comprising:
an expansion tank configured to accommodate for an expansion of the fluid as a temperature of the fluid rises and to stabilize a fluid pressure in the supply and return conduits.

6. The hydronic heating system of claim 1, wherein the first zone further comprises:
a zone valve configured to permit or stop a flow of the fluid through the first zone pipe; and
a thermostat configured to detect a temperature of the first space and to control the zone valve to stop the flow of the fluid when the temperature of the fluid reaches a set point.

7. The hydronic heating system of claim 6, wherein the thermostat is further configured to control an on/off state of the first terminal unit.

8. The hydronic heating system of claim 6, wherein the first zone further comprises:
a bypass path configured to permit limited flow of heating fluid through the first zone even when the zone valve is closed.

9. The hydronic heating system of claim 1, wherein the first terminal unit comprises a fan coil, a radiator, or a heat pump.

10. The hydronic heating system of claim 1, further comprising:
a second zone comprising:
a second zone pipe fluidically coupled to the supply and return conduits and configured to carry the fluid from the chiller;
a second terminal unit coupled to the second zone pipe and configured to extract thermal energy from the second zone pipe and to provide heat to a first space corresponding to the second zone; and
a second thermal valve located along the second zone pipe and configured to passively regulate a flux of fluid through the second zone pipe by reducing the flux of fluid as a temperature of the fluid rises,
wherein the second thermal valve is configured to regulate the flux of fluid independent of the first thermal valve.

11. The hydronic heating system of claim 1, further comprising:
a third thermal valve located along the return conduit and configured to passively regulate a flux of fluid through the return conduit independently from the first thermal valve.

12. A hydronic cooling system comprising:
a supply conduit configured to remove a fluid from a chiller, the chiller being configure to cool the fluid;
a return conduit configured to return the fluid to the chiller; and
a first zone comprising:
a first zone pipe fluidically coupled to the supply and return conduits and configured to carry fluid from the chiller;
a first terminal unit coupled to the first zone pipe and configured to facilitate exchange of thermal energy between the first zone pipe and a first space corresponding to the first zone; and
a first thermal valve located along the first zone pipe and configured to passively regulate a flux of fluid through the first zone pipe by increasing the flux of fluid as a temperature of the fluid rises.

13. The hydronic cooling system of claim 12, wherein the fluid is water.

14. The hydronic cooling system of claim 12, wherein the first thermal valve comprises a heat-sensitive material configured to expand and open the first thermal valve when water when the temperature of the water exceeds an opening temperature, and to contract and close the first thermal valve when the temperature of the water is below the opening temperature.

15. The hydronic cooling system of claim 12, further comprising:
a circulation pump located along the supply conduit or return conduit, and configured to pump the fluid through the supply and return conduits; and
a control unit for controlling an on/off state and/or a speed of the circulation pump.

16. The hydronic cooling system of claim 12, further comprising:
an expansion tank configured to accommodate for an expansion of the fluid as a temperature of the fluid rises and to stabilize a fluid pressure in the supply and return conduits.

17. The hydronic cooling system of claim 12, wherein the first zone further comprises:
a zone valve configured to permit or stop a flow of the fluid through the first zone pipe; and
a thermostat configured to detect a temperature of the first space and to control the zone valve to stop the flow of the fluid when the temperature of the fluid reaches a set point.

18. The hydronic cooling system of claim 17, wherein the thermostat is further configured to control an on/off state of the first terminal unit.

19. The hydronic cooling system of claim 17, wherein the first zone further comprises:
a bypass path configured to permit limited flow of cooling fluid through the first zone even when the zone valve is closed.

20. The hydronic cooling system of claim 12, wherein the first terminal unit comprises a fan coil or a radiator.

21. The hydronic cooling system of claim 12, further comprising:
a second zone comprising:
a second zone pipe fluidically coupled to the supply and return conduits and configured to carry the fluid from the chiller;
a second terminal unit coupled to the second zone pipe and configured to facilitate exchange of thermal energy between the second zone pipe and a second space corresponding to the second zone; and
a second thermal valve located along the second zone pipe and configured to passively regulate a flux of fluid through the second zone pipe by increasing the flux of fluid as a temperature of the fluid rises,
wherein the second thermal valve is configured to regulate the flux of fluid independent of the first thermal valve.

22. The hydronic cooling system of claim 12, further comprising:
a third thermal valve located along the return conduit and configured to passively regulate a flux of fluid through the return conduit independently from the first thermal valve.
